(19) United States
(12) Patent Application Publication
(10) Pub. No.: US 2023/0323714 A1
(43) Pub. Date: Oct. 12, 2023

(54) FRICTION HINGE FOR OUTWARD OPENING TOP HUNG WINDOWS

(71) Applicants: Andrey Borisovich STREPETOV, Saint Petersburg (RU); Kirill Sergeevich KRAPKIN, Saint Petersburg (RU); Vitaliy Gennad'evich FRANCEV, Saint Petersburg (RU)

(72) Inventors: Andrey Borisovich STREPETOV, Saint Petersburg (RU); Kirill Sergeevich KRAPKIN, Saint Petersburg (RU); Vitaliy Gennad'evich FRANCEV, Saint Petersburg (RU)

(21) Appl. No.: 18/022,288

(22) PCT Filed: Jun. 8, 2021
(86) PCT No.: PCT/RU2021/050160

§ 371 Date: Feb. 21, 2023

(30) Foreign Application Priority Data
Sep. 15, 2020 (RU) 2020130560

(51) Int. Cl. E05D 7/086

(52) U.S. Cl. CPC E05D 7/086; E05Y 2900/148; E05Y 2201/626; E05Y 2201/708; E05Y 2201/478

(57) ABSTRACT

A friction hinge for outward opening top hung windows comprising a support guide of C-shaped section, a moving lever, intermediate levers, a sliding block mounted so that it is capable to slide in the support guide, which are pivotally connected to each other and provide opening of the movable lever in its plane, wherein its rotation axis simultaneously slides along the guide and moves away from it in the opening direction.

### TECHNICAL FIELD

The technical solution relates to building and construction, may be used in windows with outward opening sashes, and is designed for opening of top hung windows, in particular, mansard windows.

### BACKGROUND

A technical solution of patent CN203430231U “Sliding support” is known, application of 25 Jul. 2013. The patent describes a design of a friction hinge of “scissor stay” type, which contains a guide support, a sliding block installed in the guide, a lever mechanism with a movable lever for attachment to the openable window sash, a limiting block with a movable locking element and an elastic element, wherein the limiting unit is movably mounted in the guide and connected to the sliding block, the movable element with an axis and the elastic element are movably mounted in the cavity of the limiting block so that, due to the shape of the cavity of the movable and elastic elements, the movable element is able to slide and rotate in the cavity, moving from the fixation position to the position of free movement of the limiting block and back, while moving the sliding block when moving the sash mounting lever, wherein fixation is provided by engagement of the movable element with holes formed in one of the sliding grooves.

The hinge may be used in windows with sashes having vertical opening axis. The hinge is designed for limiting free opening of the sash from a fixed intermediate opening position but does not prevent from spontaneous closing of the sash, as moving of the sash towards the closed position is limited only by friction force of hinge moving parts, which can be insufficiently safe for top hung windows with relatively heavy sashes.

A technical solution of “MARCO INOX Adjustable multiposition arm for opening out” is known, which is represented on Savio S.p.A. web-site available through the link https://www.savio.it/prodotti.php?id_art=301&ln=ru on 27 Aug. 2020. The limiter contains a body in the form of a closed guide with holes in one of its sides in the form of grooves, a moving part mounted inside the guide and capable to slide along it, wherein the moving part has a cavity, inside which a retainer and an elastic element are movably mounted, the shape of the cavity, of the retainer, of the elastic element enable the retainer to move in the free movement position of the moving part along the guide and the position of fixing, in which the retainer prevents the limiter to fold, fixing positions are determined by the holes in the guide, and the change of the retainer position is performed by its interaction with the holes in the guide and inner surfaces of the guide and moving part cavity and the elastic element. Moreover, when the moving part of the limiter is moved out, the retainer occupies the fixing position preventing the limiter to fold by interaction with each hole of the guide, which it passes consequently not inhibiting the moving part to move out. The folding of the limiter may be performed from any fixing position, to do this the moving part is moved out till switching the retainer into the free movement position, which it occupies when positioned between two holes of the guide, after that the moving part of the limiter may be moved in into the original position or any other intermediate position. The limiter is design for the use as a supplementary element in window casings with sashes and, in particular, top hung windows with outward opening sashes and “scissor stay” hinges.

Different designs of “scissor stay” hinges for windows with top hung outward opening sashes are known, for example, those represented on Savio S.p.A. web-site available through the link https://www.savio.it/prodotti.php?id_art=1807&ln=ru and https://www.savio.it/prodotti.php?id_art=1804&ln=ru on 27 Aug. 2020.

The closest technical solution of Russian utility model patent No. 57787 “Friction Hinge for Outward Opening Windows”, application of 14 Jun. 2006, is chosen as a prototype. A friction hinge for outward opening windows is implemented in the form of an arm-lever mechanism, containing a support lever, one end of which is pivotally connected to a window sash, and the other is rotationally connected to the window frame, an intermediate lever, one end of which is pivotally connected to the support lever, and the other to the window frame with an ability to slide, and a locking element, the hinge is additionally equipped with a C-shaped section guide and a bar statically mounted on the frame and the sash correspondingly, and a supplementary lever, in the lower part of the guide there is a zone with punching and a stop is mounted, in the upper part a slider of U-shaped section is mounted with an ability of reciprocating motion, and a locking cap is rigidly mounted, in the zone with punching and on the slider the ends of the support lever, intermediate lever and supplementary levers are pivotally fixed, the other ends of the support lever and supplementary levers are pivotally fixed on the bar, wherein inside the slider there is an insert forming a spacing between the end faces of the sidewalls of the slider and the guide, in the slider and the spacer there are a central hole for an adjustment screw, wherein the hole in the spacer is blind, and two pass-through holes for intermediate and supplementary lever pivots, located symmetrically relative to the central hole, moreover the top end of the bar is equipped with a locking shoe, and in the pivot connections there are washers. This hinge can be used in outward opening top hung windows. The drawback of the prototype consists in using only the friction force for fixing the position of the sash in opened intermediate positions, which can be not sufficient for holding sashes of relatively big weight or preventing spontaneous moving of the sash due to strong gusts, thus the design of the hinge does not provide reliable fixing of the sash in an opened or partly opened position.

### SUMMARY OF THE INVENTION

A friction hinge for outward opening top hung windows comprising a support guide of C-shaped section, a moving lever, intermediate levers, a sliding block mounted so that it is capable to slide in the support guide, which are pivotally connected to each other and provide opening of the movable lever in its plane, wherein its rotation axis simultaneously slides along the guide and moves away from it in the opening direction, wherein the hinge is supplemented by a limiting block implemented in the form of a sliding block, mounted so that it is capable to slide in the support guide and connected with the main sliding block, the limiting block has a movable locking element and an elastic element located in a cavity of the limiting block, in the support guide, on the side of the cavity, there are at least two holes for interaction with the movable locking element of the limiting block, the movable locking element is made in the form of an extended body and has:
on the top at its end on the side of the main sliding block, an upper end locking lug with a stop surface at the end and with an inclined surface at the opposite side of the lug along its length,
on the top in the area of the middle, an upper curved positioning lug,
a support end at the side opposite to the position of the end locking lug,
on the bottom at a space from the support end, a support lug,
an area with the inclined surface in the bottom from the side of the elastic element which provides a taper to the end of the movable locking element,
the cavity of the limiting block has:
a step lug from the side of the support end of the movable locking element,
a support lug in the area of the middle of the cavity length,
a spacing between lugs of the cavity,
a spacing of the cavity for receiving the elastic element from the side of the upper end locking lug,
a movable locking element is mounted so as to slide and pivot in the cavity when its parts interact with the surface of the guide, the elastic element, and parts of surfaces of the cavity during moving of the limiting block along the guide,
doing this, the following possible positions of the limiting block are provided:
a free movement position, where due to the elastic element the upper curved lug of the locking element is pressed to the internal surface of the guide, the lower support lug and the support end of the locking element abut against the step lug of the cavity, and the upper end locking lug does not touch the surface of the guide,
a locking position, where due to the pressing by the elastic element the upper end locking lug of the movable locking element is located in the hole for locking position in the guide, the upper curved positioning lug rests on the internal surface of the guide, the lower support lug by its side surface abuts against the side surface of the support lug of the cavity and together with the support end are located in the spacing of the cavity between its step lug and support lug,
a position of limiting of hinge closing, where the end locking lug is located in the hole of the guide and abuts against the wall of the last by its stop surface, the support end of the locking element abuts against the step lug of the cavity,
also, the design provides possibility of switching the position of the movable locking element from the locking position or the position of limiting of closing into the free movement position from an intermediate position provided by the holes in the guide,
moreover, the hinge has an extreme hinge opening position, where the possibility of going out of the curved positioning lug into the last hole of the guide for switching the movable locking element into the free movement position of the limiting block is provided, wherein the upper end locking lug in the extreme hinge opening position remains under the surface of the guide.

### Technical Problem

A technical result consists in increasing reliability of a friction hinge together with increasing safety of its use.

### Solution of the Problem

The technical result is achieved due to that the hinge comprising a support guide of C-shaped section, a moving lever, intermediate levers, a sliding block mounted so that it is capable to slide in the support guide, which are pivotally connected to each other and provide opening of the movable lever in its plane, wherein its rotation axis simultaneously slides along the guide and moves away from it in the opening direction,
the hinge is supplemented by a limiting block implemented in the form of a sliding block, mounted so that it is capable to slide in the support guide and connected with the main sliding block,
the limiting block has a movable locking element and an elastic element located in a cavity of the limiting block,
in the support guide, on the side of the cavity, there are at least two holes for interaction with the movable locking element of the limiting block,
the movable locking element is made in the form of an extended body and has
on the top at its end on the side of the main sliding block, an upper end locking lug with a stop surface at the end and with an inclined surface at the opposite side of the lug along its length,
on the top in the area of the middle, an upper curved positioning lug,
a support end at the side opposite to the position of the end locking lug,
on the bottom at a space from the support end, a support lug,
an area with the inclined surface in the bottom from the side of the elastic element which provides a taper to the end of the movable locking element,
the cavity of the limiting block has
a step lug from the side of the support end of the movable locking element,
a support lug in the area of the middle of the cavity length,
a spacing between lugs of the cavity,
a spacing of the cavity for receiving the elastic element from the side of the upper end locking lug,
a movable locking element is mounted so as to slide and pivot in the cavity when its parts interact with the surface of the guide, the elastic element, and parts of surfaces of the cavity during moving of the limiting block along the guide,
doing this, the following possible positions of the limiting block are provided:
a free movement position, where due to the elastic element the upper curved lug of the locking element is pressed to the internal surface of the guide, the lower support lug and the support end of the locking element abut against the step lug of the cavity, and the upper end locking lug does not touch the surface of the guide,
a locking position, where due to the pressing by the elastic element the upper end locking lug of the movable locking element is located in the hole for locking position in the guide, the upper curved positioning lug rests on the internal surface of the guide, the lower support lug by its side surface abuts against the side surface of the support lug of the cavity and together with the support end are located in the spacing of the cavity between its step lug and support lug,
a position of limiting of hinge closing, where the end locking lug is located in the hole of the guide and abuts against the wall of the last by its stop surface, the support end of the locking element abuts against the step lug of the cavity,
also, the design provides possibility of switching the position of the movable locking element from the locking position or the position of limiting of closing into the free movement position from an intermediate position provided by the holes in the guide,
moreover, the hinge has an extreme hinge opening position, where the possibility of going out of the curved positioning lug into the last hole of the guide for switching the movable locking element into the free movement position of the limiting block is provided, wherein the upper end locking lug in the extreme hinge opening position remains under the surface of the guide.

The upper curved positioning lug is located in the area of the middle of the length of the movable locking element, wherein its inclined surfaces on both sides and the pressing effect of the elastic element provide possibility to create a stop at the walls of the holes in the guide, which allows the movable locking element to slide in the cavity, moreover, inclined surfaces enable to lower the movable locking element under the guide due to interaction of lugs of the movable locking element and the cavity while moving the limiting block. The distance over the length from the upper point of the upper curved positioning lug to each end of the movable locking element is greater than the length of the holes of intermediate positions in the guide.

The support lug of the cavity can be located in an area under the curved positioning lug of the movable locking element in its extreme position in the cavity when the lower support lug contacts with the step lug of the cavity.

The design of the hinge can be supplemented by an elastic element connecting the guide and the sliding block and having possibility to act in the direction of moving of the sliding block along the guide. The elastic element can provide additional force facilitating opening of the hinge and/or damping closing of the hinge.

As the elastic element a gas spring can be used, a gas strut with a cylinder and a rod connecting the guide and the sliding block, and connected to the last through a long slot in the guide from the side opposite to the sliding block mounting side.

The sliding block and the limiting block can be implemented in the form of a part with one solid base.

The cavity of the limiting block can be implemented partly open from the side of the flat part of the guide, wherein the movable locking element and the elastic element located in the cavity can be hold by the internal surface of the guide.

There is a possible application of the solution in the design of the hinge intended for windows with a sash of relatively small size and weight and which contains a C-shaped section support guide, a movable lever, intermediate levers, a sliding block mounted so that it is capable to slide in the support guide, a stop in the upper part of the guide for the upper part of the movable lever, a lower intermediate lever is pivotally connected with one end to the lower part of the support guide and with the other end to the lower part of the movable lever, an upper intermediate lever is pivotally connected with one end to the upper part of the movable lever and with the other end to the sliding block, the middle intermediate lever is pivotally connected with one end to the sliding block and with the other end to the lower intermediate lever, between its pivot connections.

There is another possible application of the solution in the design of the hinge intended for windows with a sash of relatively large size and weight and which contains a C-shaped section support guide, a movable lever, intermediate levers, a sliding block mounted so that it is capable to slide in the support guide, a stop in the upper part of the guide for the upper part of the movable lever, a lower intermediate lever is pivotally connected with one end to the lower part of the support guide and with the other end to the lower part of the movable lever, an upper intermediate lever is pivotally connected with one end to the upper part of the movable lever and with the other end to the sliding block, the middle intermediate lever is pivotally connected with one end to the sliding block and with the other end to the lower intermediate lever, between its pivot connections, the first additional lever pivotally connects the movable lever and the middle intermediate lever in their middle areas, the second additional lever pivotally connects the lower intermediate lever with the second sliding block movably mounted on the guide.

In the case when the guide has two holes, the first hole in the direction of movement of the sliding block is a hole for an intermediate locking position of the movable lever of the hinge, and the second, the last, is the hole of the extreme position of the opening of the movable lever and is used for switching the limiting block into the free movement position for folding the movable lever of the hinge into the original closed position.

The guide may have more than two holes, the last one in the in the direction of movement of the sliding block is the hole of the extreme position of movable lever opening, and others are holes for intermediate locking positions of the movable lever of the hinge.

### Positive Effects of the Invention

Reliability is increased due to the use of a retainer in the hinge design, which rigidly locks intermediate positions of the movable lever of the hinge for mounting a window sash and prevents its spontaneous closing.

The mechanism of the limiter consequently actuates in all provided intermediate positions of holes, which it passes during the monodirectional movement of the sash in the opening direction. The sash can be returned into the closed position from any intermediate position.

The technical solution offered provides implementation of functions of opening and positioning in intermediate positions for the sash preventing its occasional closing, operating properties are improved due to that the sash can be closed from any intermediate position, as well as due to a high safety factor and reliability of the structure.

### BRIEF DESCRIPTION OF DRAWINGS

FIG. 1 illustrates the general view of the hinge.

FIG. 2 illustrates the hinge, side view as seen from the sliding block position in the guide.

FIG. 3 illustrates the limiting block, general view.

FIG. 4 illustrates the limiting block, side view.

FIG. 5 illustrates the limiting block mounted in the guide, free movement position.

FIG. 6 illustrates the limiting block mounted in the guide, intermediate position of the movable locking element.

FIG. 7 illustrates the limiting block mounted in the guide, intermediate position of the movable locking element.

FIG. 8 illustrates the limiting block mounted in the guide, intermediate position of the movable locking element.

FIG. 9 illustrates the limiting block mounted in the guide, intermediate position of the movable locking element.

FIG. 10 illustrates the limiting block mounted in the guide, locked position.

FIG. 11 illustrates the limiting block mounted in the guide, position of limiting of hinge closing.

FIG. 12 illustrates the limiting block mounted in the guide, extreme position of hinge opening.

FIG. 13 illustrates the limiting block mounted in the guide, position of transfer into the free movement position in the area of the extreme position of hinge opening.

FIG. 14 illustrates the limiting block mounted in the guide, free movement position.

FIG. 15 illustrates a mansard window with an opened sash on the hinges.

### DESCRIPTION OF EMBODIMENTS

The illustrations contain the following notations:

1—guide

2—movable lever of the hinge

3—intermediate levers

4—sliding block

5—stop for the upper part of the movable lever

6—limiting block

7—cavity of the limiting block

8—movable locking element

9—elastic element

10—support end of the locking element

11—lower support lug

12—upper curved positioning lug

13—upper end locking lug

14—lower beveled surface of the movable locking element

15—step lug of the cavity

16—support lug of the cavity

17—spacing between lugs of the cavity

18—spacing of the cavity for the elastic element

19—holes for locking positions in the guide

20—distance between the holes

21—hole of the extreme position

22—gas spring

23—hinge assembly

24—window frame

25—window sash

26—glass unit

27—facing element of the window

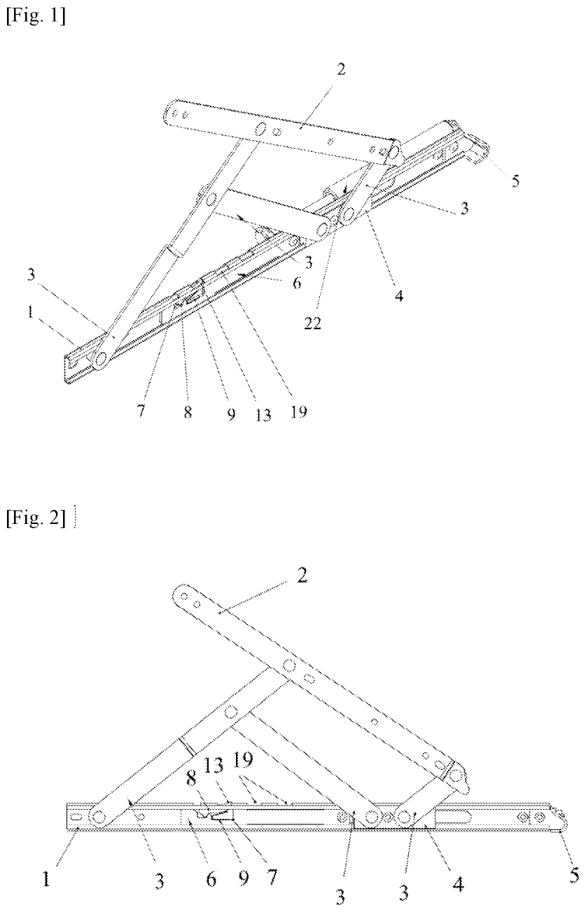

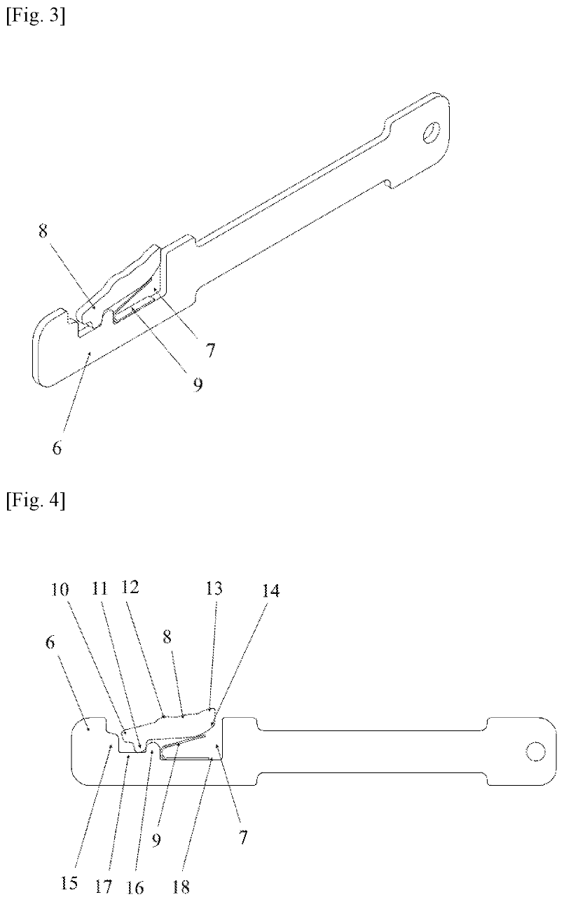

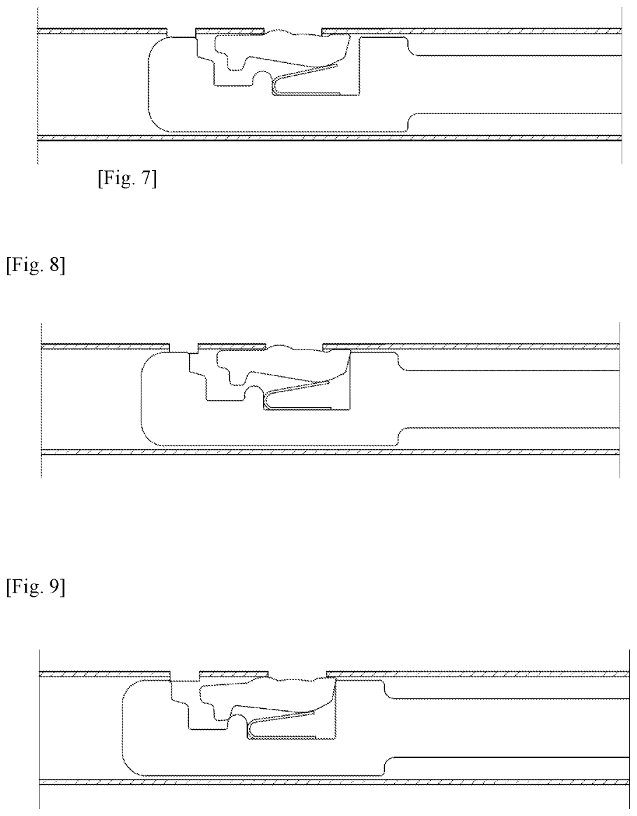

The hinge in FIG. 1 and FIG. 2 has a support guide 1, a movable lever 2, three intermediate levers 3, a sliding block 4 mounted so that it can slide in the support guide 1, to which two intermediate levers 3 are pivotally attached, a stop 5 in the upper part of the guide 1 for the upper part of the movable lever 2, the lower intermediate lever is pivotally connected with one end to the lower part of the support guide 1 and with the other end to the lower part of the movable lever 2, the upper intermediate lever 3 is pivotally connected with one end to the upper part of the movable lever 2 and with the other end to the sliding block 4, the middle intermediate lever is pivotally connected with one end to the sliding block 4 and with the other end to the lower intermediate lever, between its pivot connections,
a limiting block 6 in FIG. 3-FIG. 14 is mounted in the guide 1 as so to be capable to slide and is connected to the sliding block 4, in the limiting block 6 there is a cavity 7, in which there is an elastic element 9 and a movable locking element 8, the cavity 7 has a step lug 15, a support lug 16, a spacing 17 between these lugs, a spacing 18 to receive the elastic element 9,
the movable locking element 8 and the elastic element 9 are hold within the cavity 7 by the internal surface of the guide 1 and from the opened side of the guide by the internal surface of the stop member (not shown in the figure),
the movable locking element 8 is implemented in the form of a plain extended body and has a support end 10 from the side of the step lug 15 of the cavity 7, a lower support lug 11, an upper curved positioning lug 12 in the area of the middle of the length, and an upper end locking lug 13 and a lower beveled surface 14 from the side of an area of a cavity for the elastic element,
in the guide 1 there are holes 19 for locking positions and a hole 21 of the extreme position made through distances 20.

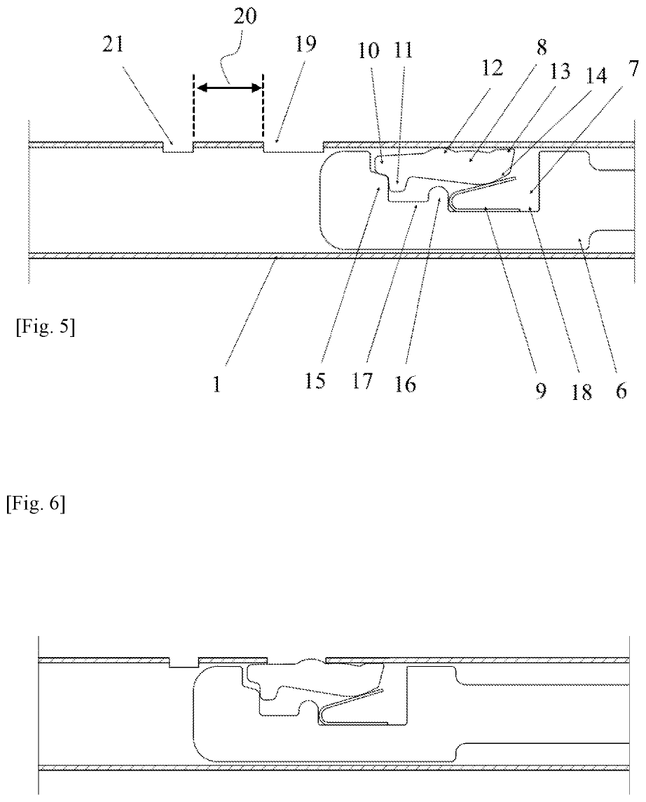

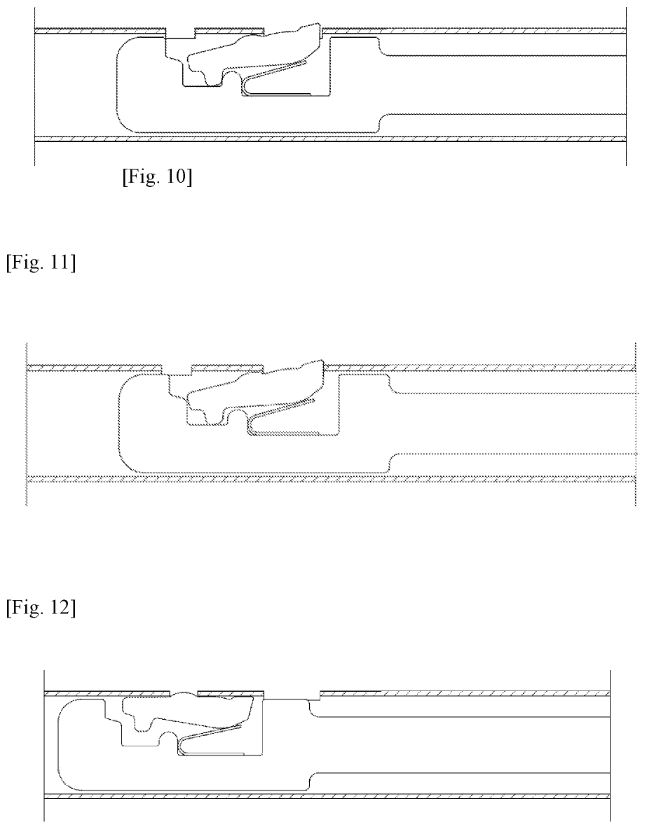

The movable locking element 8 is capable to move, namely, to slide and to tilt, in the cavity 7 when its parts interact with the surface of the guide 1, an elastic element 9 and parts of the cavity 7. It can take free movement positions in FIG. 5, locking position in FIG. 10, position of limiting of closing in FIG. 11.

The shape of the curved lug 12 is made in the form of an arc and provides sliding under the surface of the guide 1 while moving. The distance between the upper point of the curved lug 12 and the end of the upper end locking lug 13 is greater than the length of holes 19 for locking positions in the guide 1. The length of the extreme position 21 in the guide provides that the curved lug 12 can emerge into it.

The hinge has the extreme opening position when the upper end locking lug 13 does not emerge into the hole 21 of the extreme position but remains under the surface of the guide 1.

The lower beveled surface 14 of the movable locking element 8 provides better interaction with the elastic element 9 and possibility to create directed pressing force of the movable locking element 8 to the surface of the guide 1 and parts of the cavity 7.

On the side opposite to one of the sliding block mounting a gas spring 22 made in the form of a gas strut with a cylinder and a rod is mounted on the guide. One end of the gas spring is connected to the guide 1, and the other to the sliding block 4 through a slot in the guide 1. The gas spring 22 facilitates opening of the hinge and has damping action while closing.

The hinge operates as follows.

The original free movement position of the limiting block, FIG. 5.

In the original closed position of the movable lever 2 of the hinge the movable locking element 8 is located in the cavity 7 of the limiting block 6 in its free movement position, when due to the elastic element 9 the upper curved lug 12 of the locking element 8 is pressed to the inner surface of the guide 1, and the lower support lug 11 of the locking element 8 abut against the step lug 15 of the cavity, wherein the upper locking lug 13 does not touch the surface of the guide and does not prevent movement of the limiting block 6.

Transition from the free movement position of the limiting block to the locking position and the position preventing the hinge to close from the required opening position, FIG. 6-11.

During moving of the movable lever 2 of the hinge in the opening direction the main sliding block 4 moves together with the limiting block 6 along the guide 1 with the holes 19 for locking positions. When the locking element 8 passes the limiting block 6 of the first hole 19 for locking position, first, due to the pressure of the elastic element 9 the upper curved positioning lug 12 enters the hole. With further movement the upper curved lug 12 abut against the edge of the hole 19 of the guide 1, due to this the movable locking element 8 starts to shift inside the cavity 7 in the direction opposite to the motion, wherein the support end 10 and the lower support lug 11 move from the step lug 15 of the cavity 7 and shift along the spacing 17 of the cavity between its step lug 15 and support lug 16. With further movement, the lower support lug 11 abuts against the lug 16 of the cavity 7 engaging the lug, the upper curved lug 12 lowers and passes under the guide 1, after this the upper end locking lug 13 enters the hole 19 due to the elastic element 9. In this way the limiting block 6 switches into the locking position, FIG. 10, where due to the pressing by the elastic element 9 the upper end locking lug 13 of the movable locking element 8 is located in the hole 19 for locking position in the guide 1, the upper curved positioning lug 12 rests on the internal surface of the guide 1, the lower support lug 11 abuts against the support lug 16 of the cavity 7 and together with the support end are located in the lower point of the spacing 17 of the cavity between its step lug 15 and support lug 16. The arrangement of the mechanism of the limiting block 6 allows to freely move the movable lever 2 of the hinge to a required position of opening determined by the holes 19 in the guide 1, wherein the upper end locking lug 13 of the movable locking element 8 will lower under the surface of the guide 1 and consequently emerge in every hole 19 which it passes.

Locking of the position is effected during the inverse movement, when the hinge is opened to a required position, and the upper end locking lug 13 enters the corresponding hole 19 of the guide 1 due to the pressing by the elastic element 9. Doing this, the end locking lug 13 abut against the edge of the hole 19 of the guide 1, due to this the movable locking element 8 shifts in the direction opposite to the motion, and the support end 10 and the lower support lug 11 move from the support lug 16 of the cavity 7 in the direction of its step lug 15. With further movement in the direction of closing the support end 10 of the locking element 8 abuts the lower part of the step lug 15 of the cavity 7, due to this locking of the limiting block 6 on the guide 1 is achieved, consequently, of the sliding block 4 and movable lever 2 of the hinge and prevention of its free closing form the required locking position.

Transition from the locking position of the limiting block in the free movement position, FIG. 10-14.

The movable lever 2 of the hinge may be transferred from a locked position, FIG. 11, into a free movement position, FIG. 14, from any intermediate locking position which are provided with holes 19 in the guide 1. To do this, the movable lever 2 of the hinge being in a locking position, is moved in the opening direction up to the limiting block position, FIG. 12, in which the upper curved positioning lug 12 enters the next hole in the guide 19 or 21 due to pressing of the movable locking element 8 by an elastic element 9, wherein the support end of the locking element 10 and the lower support lug 11 are elevated, and upper end locking lug 13 remains under the spacing of the guide 1 between the holes 19 or 19 and 21. In this position the movable lever 2 of the hinge is stopped and the reverse motion in the direction of closing is started.

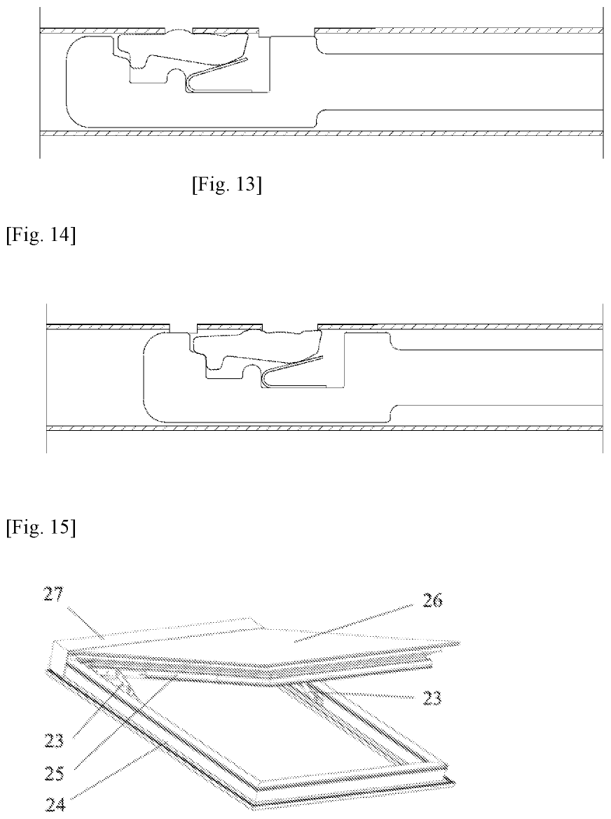

In the reverse motion from the described position the upper curved positioning lug 12 of the locking element 8 abuts the extreme edge of the hole 19 or 21, due to this during further movement the movable locking element 8 shifts in the cavity 7 in the direction inverted to the reverse motion. Further the support end 10 of the locking element 8 passes over the step lug 15 of the cavity 7, and the lower support lug 11 abuts against it, FIG. 13. In further movement, FIG. 14, the movable locking element 8 shifts in the movement direction due to the stop of the support lug 11, wherein the upper curved positioning lug 12 passes under the surface of the guide 1 and slides on it due to the pressing by the elastic element 9, and the upper end locking lug 13 lowers and do not touch the internal surface of the guide 1.

In such a position of the movable locking element 8 the hinge can be closed completely or displaced into any other previous opening position, in which, due to the movement direction change, the position of the locking element 8 can be switched from the free movement position to the locking position, similarly to the method described above.

Extreme hinge opening position. Transition from the locking position of the limiting block in the free movement position.

In the guide 1 there is a hole of the extreme position 21 located behind the last hole 19 for locking position. Its size provides receiving the upper curved positioning lug 12 of the movable locking element 8. The extreme hinge opening position is made so that when the hinge is opened the upper curved positioning lug 12 is capable to enter the hole 21 of the extreme position, wherein the upper end locking lug 13 remains under the surface of the guide 1 and in the extreme hinge opening position does not have possibility to go out into the hole 21 of the extreme position. Availability of the hole 21 of the extreme position enables to switch the position of the movable locking element 8 of the limiting block 6 similarly to the method described above, from the locking position in the previous hole 19 to the free movement position for full hinge closing or partial closing up to a required intermediate position.

FIG. 15 illustrates a mansard window with a facing element 27, in which a pair of hinges 23 described herein is applied, one of them is left-side and the other is right-side. The hinges are installed in the opening between a frame 24 and a sash 25. The guide 1 of each hinge 23 is attached to the frame 24, and the window sash 25 with a glass unit 26 is mounted on the movable levers 2.

The described design of the hinge may be applied in top hung outward opening windows, such as, for example, mansard windows, or any other windows, in which locking in intermediate opening positions and preventing of free spontaneous closing of sashes is desirable.

### Industrial Applicability

The claimed invention complies with the requirement of industrial applicability as it can be implemented with the use of existing technical means.

### References

Patent document 1: Patent 2014—CN 203430231.

Patent document 2: Patent 2006—RU 57787.

Non-patent document 3: Savio S.p.A. website: https://www.savio.it/prodotti.php?id_art=301&ln=ru.

Non-patent document 4: Savio S.p.A. website: https://www.savio.it/prodotti.php?id_art=1807&ln=ru.

Non-patent document 5: Savio S.p.A. website: https://www.savio.it/prodotti.php?id_art=1804&ln=ru.

1. A friction hinge for outward opening top hung windows, the fringe hinge comprising:
a support guide of C-shaped section,
a moving lever,
intermediate levers,
a sliding block mounted and configured to and/or capable to slide in the support guide, which are pivotally connected to each other and provide opening of the movable lever in a plane, wherein the rotation axis of the movable lever simultaneously slides along the guide and moves away from the guide in the opening direction, wherein the hinge is supplemented by a limiting block implemented in the form of a sliding block, mounted and configured to and/or capable to slide in the support guide and connected with the main sliding block, the limiting block has a movable locking element and an elastic element located in a cavity of the limiting block, in the support guide, on the side of the cavity, there are at least two holes for interaction with the movable locking element of the limiting block, the movable locking element is made in the form of an extended body and has: on the top at an end on the side of the main sliding block, an upper end locking lug with a stop surface at the end and with an inclined surface at the opposite side of the lug along a length, on the top in the area of the middle, an upper curved positioning lug, a support end at the side opposite to the position of the end locking lug, on the bottom at a space from the support end, a support lug, an area with the inclined surface in the bottom from the side of the elastic element which provides a taper to the end of the movable locking element, the cavity of the limiting block has: a step lug from the side of the support end of the movable locking element, a support lug in the area of the middle of the cavity length, a spacing between lugs of the cavity, a spacing of the cavity for receiving the elastic element from the side of the upper end locking lug, a movable locking element is mounted so as to slide and pivot in the cavity when parts of the locking element interact with the surface of the guide, the elastic element and parts of surfaces of the cavity during moving of the limiting block along the guide, doing this, the following possible positions of the limiting block are provided: a free movement position, where due to the elastic element the upper curved lug of the locking element is pressed to the internal surface of the guide, the lower support lug and the support end of the locking element abut against the step lug of the cavity, and the upper end locking lug does not touch the surface of the guide, a locking position, where due to the pressing by the elastic element the upper end locking lug of the movable locking element is located in the hole for locking position in the guide, the upper curved positioning lug rests on the internal surface of the guide, the lower support lug by a side surface abuts against the side surface of the support lug of the cavity and together with the support end are located in the spacing of the cavity between a step lug and support lug, a position of limiting of hinge closing, where the end locking lug is located in the hole of the guide and abuts against the wall of the last by a stop surface, the support end of the locking element abuts against the step lug of the cavity, also the design provides possibility of switching the position of the movable locking element from the locking position or the position of limiting of closing into the free movement position from an intermediate position provided by the holes in the guide, moreover, the hinge has an extreme hinge opening position, where the possibility of going out of the curved positioning lug into the last hole of the guide for switching the movable locking element into the free movement position of the limiting block is provided, wherein the upper end locking lug in the extreme hinge opening position remains under the surface of the guide.

2. The friction hinge of claim 1, further comprising: an elastic element connecting the guide and the sliding block and having possibility to act in the direction of moving of the sliding block along the guide.

3. The friction hinge of claim 2, wherein a gas spring with a cylinder and a rod connecting the guide and the sliding block is used as the elastic element, and connected to the last through a long slot in the guide from the side opposite to the sliding block mounting side.

4. The friction hinge of claim 1, wherein the sliding block and the limiting block are implemented in the form of a part with one solid base.

5. The friction hinge of claim 1, wherein the cavity of the limiting block is implemented partly open from the side of the flat part of the guide, and wherein the movable locking element and the elastic element located in the cavity are hold by the internal surface of the guide.

6. The friction hinge of claim 1, further comprising: a C-shaped section support guide, a movable lever, intermediate levers, a sliding block mounted configured to and/or capable to slide in the support guide, a stop in the upper part of the guide for the upper part of the movable lever, a lower intermediate lever is pivotally connected with one end to the lower part of the support guide and with the other end to the lower part of the movable lever, an upper intermediate lever is pivotally connected with one end to the upper part of the movable lever and with the other end to the sliding block, the middle intermediate lever is pivotally connected with one end to the sliding block and with the other end to the lower intermediate lever, between pivot connections.

7. The friction hinge of claim 1, further comprising: a C-shaped section support guide, a movable lever, intermediate levers, a sliding block mounted configured to and/or capable to slide in the support guide, a stop in the upper part of the guide for the upper part of the movable lever, a lower intermediate lever is pivotally connected with one end to the lower part of the support guide and with the other end to the lower part of the movable lever, an upper intermediate lever is pivotally connected with one end to the upper part of the movable lever and with the other end to the sliding block, the middle intermediate lever is pivotally connected with one end to the sliding block and with the other end to the lower intermediate lever, between pivot connections, the first additional lever pivotally connects the movable lever and the middle intermediate lever in their middle areas, the second additional lever pivotally connects the lower intermediate lever with the second sliding block movably mounted on the guide.
